(19) United States
(12) Patent Application Publication
(10) Pub. No.: US 2016/0335964 A1
(43) Pub. Date: Nov. 17, 2016

(54) GAMMA CURVE CORRECTION CIRCUIT AND GAMMA CURVE CORRECTION METHOD

(71) Applicant: Raydium Semiconductor Corporation, Hsinchu (TW)

(72) Inventors: Shang-Ping TANG, Zhubei City (TW); Hung LI, Taipei City (TW)

(21) Appl. No.: 15/137,659

(22) Filed: Apr. 25, 2016

Related U.S. Application Data
(60) Provisional application No. 62/162,248, filed on May 15, 2015.

(51) Int. Cl. G09G 3/36

(52) U.S. Cl. CPC G09G 3/3607; G09G 2320/0276; G09G 2320/0673

(57) ABSTRACT

A gamma curve correction circuit including a mapping module and a correction module. The mapping module maps data to be outputted into original mapped data via original bonding points on a gamma curve. The original bonding points at least include a first original bonding point, a second original bonding point, and a third original bonding point. The second original bonding point is located between the first original bonding point and third original bonding point. A first line between the first original bonding point and second original bonding point has a first slope; a second line between the second original bonding point and third original bonding point has a second slope. The correction module obtains a third line according to a first interpolating point on first line and a second interpolating point on second line. The third line has a third slope between the first slope and second slope.

### BACKGROUND OF THE INVENTION

1. Field of the Invention

This invention relates to a display apparatus, especially to a gamma curve correction circuit and a gamma curve correction method applied to a driving IC of a LCD apparatus.

2. Description of the Related Art

In general, in order to reduce the noise of the grey-level region, the LCD apparatus will perform gamma correction through the gamma correction circuit in its driving IC to decrease the gain of the grey-level region.

However, it is hard for the ordinary gamma correction circuit to finish the non-linear mapping conversion; therefore, other method such as lookup table or piecewise linear mapping conversion is necessary to finish the non-linear mapping conversion.

When the LCD panel displays codes having different sizes, the LCD panel will receive different output voltages corresponding to different code sizes respectively, and these output voltages will determine the brightness of each pixel on the LCD panel to provide different visual experiences. Even the codes having different sizes are continuously outputted, the user can have a more smooth visual experience about the brightness of the LCD panel. Please refer to FIG. 1. FIG. 1 illustrates the gamma graph of the output voltage VOUT corresponding to different output code sizes.

When the gamma correction circuit uses the piecewise linear mapping conversion method, as shown in FIG. 2, the gamma correction circuit will map the output codes into mapped codes according to the curve characteristics of the gamma curve in FIG. 1. Then, the gamma correction circuit will obtain the output voltage (VOUT) corresponding to the mapped codes according to the linear relationship between the mapped codes and the output voltage shown in FIG. 3.

However, since the number of the output codes is huge and their red (R) part, green (G) part and blue (B) part should be set up separately, if all mapped codes are stored in the registers, the cost will be too high, so that it is not easy to be realized in the driving IC. Therefore, as shown in FIG. 4, the registers are only disposed corresponding to certain original bonding points B1˜B3 on the mapped codes, and other parts of the mapped codes will be generated through the interpolation method.

The disadvantage of the above-mentioned method is that the positions of the original bonding points B1˜B3 are usually set according to the gamma curve of FIG. 1, therefore, the slope m1 of the line between the original bonding points B1 and B2 may be different from the slope m2 of the line between the original bonding points B2 and B3. When the codes having different sizes are continuously outputted, since the slope near the original bonding point B2 is changed, the grey-level continuity of the gradient picture may be poor; therefore, the user will have a poor visual experience about the brightness of the LCD panel. This disadvantage should be urgently overcome.

### SUMMARY OF THE INVENTION

Therefore, the invention provides a gamma curve correction circuit and a gamma curve correction method to solve the above-mentioned problems.

An embodiment of the invention is a gamma curve correction circuit. In this embodiment, the gamma curve correction circuit includes a mapping module and a correction module. The mapping module maps data to be outputted into original mapped data via original bonding points on a gamma curve. The original bonding points at least include a first original bonding point, a second original bonding point and a third original bonding point. The second original bonding point is located between the first original bonding point and third original bonding point. A first line between the first original bonding point and the second original bonding point has a first slope; a second line between the second original bonding point and the third original bonding point has a second slope. The correction module obtains a third line according to a first interpolating point on the first line and a second interpolating point on the second line. The third line has a third slope between the first slope and the second slope.

In an embodiment, the correction module obtains a new bonding point according to an average of the first interpolating point and the second interpolating point and uses the new bonding point to replace the second original bonding point.

In an embodiment, the gamma curve correction circuit further includes a register and an output module. The register corresponds to the first original bonding point, the third original bonding point and the new bonding point respectively and it is configured to receive and store mapped codes of the first original bonding point, the third original bonding point and the new bonding point respectively to obtain a corrected mapped code. The output module is coupled to the register and configured to output a corresponding output voltage according to the corrected mapped code.

In an embodiment, the correction module uses the first interpolating point and the second interpolating point to replace the second original bonding point.

In an embodiment, the gamma curve correction circuit further includes a register and an output module. The register corresponds to the first original bonding point, the third original bonding point, the first interpolating point and the second interpolating point respectively and it is configured to receive and store mapped codes of the first original bonding point, the third original bonding point and the first interpolating point and the second interpolating point respectively to obtain a corrected mapped code, wherein the first interpolating point and the second interpolating point output their mapped codes alternately in time or space. The output module is coupled to the register and configured to output a corresponding output voltage according to the corrected mapped code.

Another embodiment of the invention is a gamma curve correction method. In this embodiment, the gamma curve correction method is applied to a display apparatus. The gamma curve correction method includes the steps of: mapping a data to be outputted into an original mapped data via a plurality of original bonding points on a gamma curve, wherein the plurality of original bonding points at least includes a first original bonding point, a second original bonding point and a third original bonding point; the second original bonding point is located between the first original bonding point and the third original bonding point; a first line between the first original bonding point and the second original bonding point has a first slope; a second line between the second original bonding point and third original bonding point has a second slope; and obtaining a third line according to a first interpolating point on the first line and a second interpolating point on the second line, wherein the third line has a third slope and the third slope is between the first slope and the second slope.

Compared to the prior art, the gamma curve correction circuit and the gamma curve correction method of the invention can effectively improve the poor grey-level continuity of the gradient picture by correcting the bonding points where the slope is changed, so that the user can have a smooth visual experience about the brightness of the LCD panel.

The advantage and spirit of the invention may be understood by the following detailed descriptions together with the appended drawings.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates the gamma graph of the output voltage VOUT corresponding to different output code sizes.

FIG. 2 illustrates a schematic diagram of mapping the output codes into mapped codes according to the curve characteristics of the gamma curve in FIG. 1.

FIG. 3 illustrates a schematic diagram of the linear relationship between the mapped codes and the output voltage.

FIG. 4 illustrates a schematic diagram of the slope m1 of the line between the original bonding points B1 and B2 different from the slope m2 of the line between the original bonding points B2 and B3.

FIG. 5 illustrates a functional block diagram of the gamma curve correction circuit in a preferred embodiment of the invention.

FIG. 6 illustrates a schematic diagram of using a new bonding point B2′ to replace the original bonding point B2 to improve the slope change near the original bonding point B2.

FIG. 7 illustrates a flowchart of the gamma curve correction method in another preferred embodiment of the invention.

FIG. 8 illustrates a flowchart of the gamma curve correction method in still another preferred embodiment of the invention.

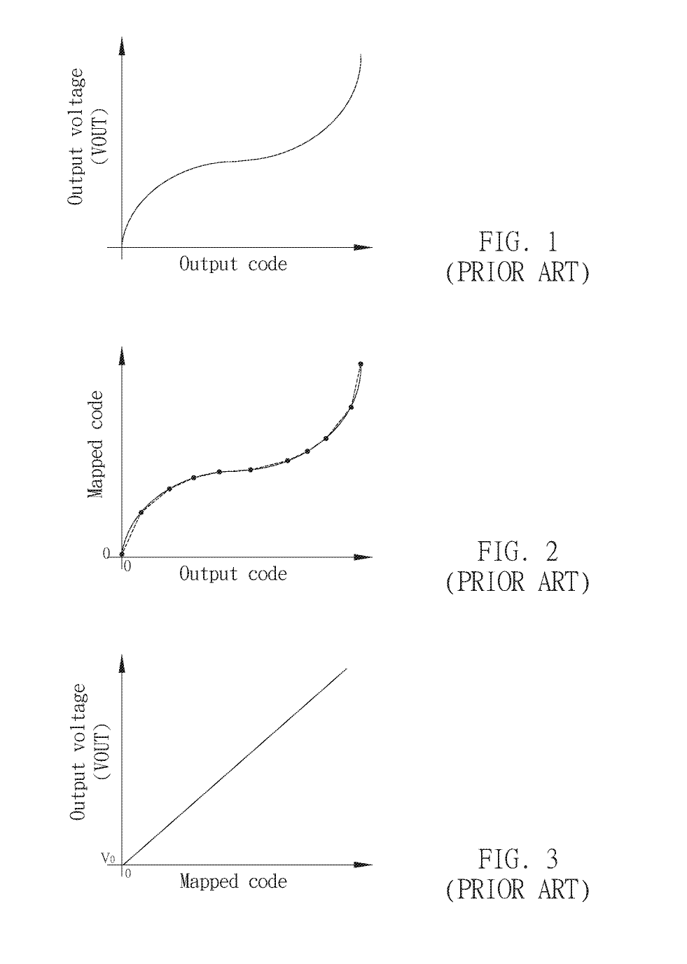

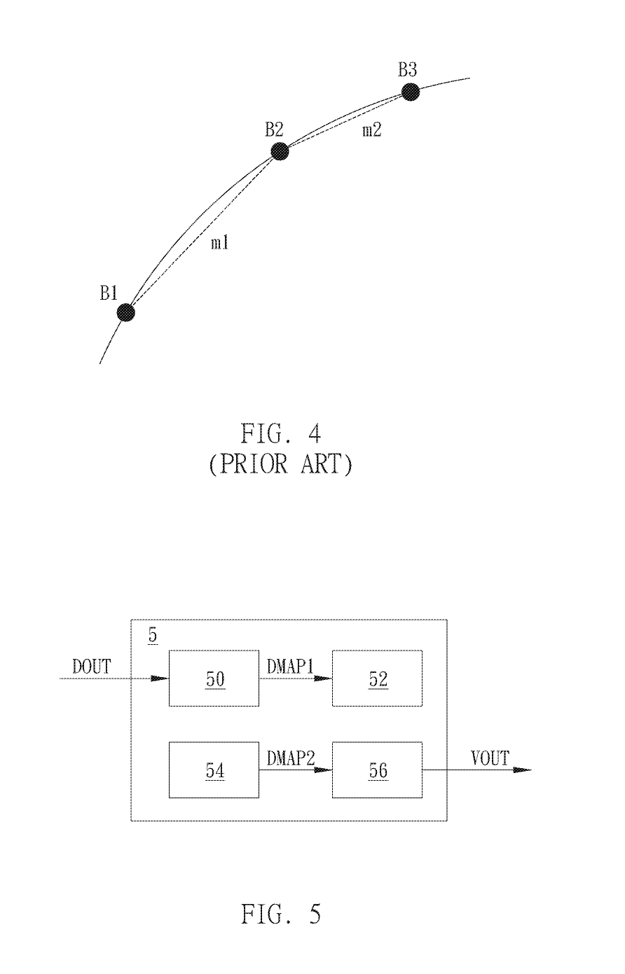

### DETAILED DESCRIPTION

A preferred embodiment of the invention is a gamma curve correction circuit. In this embodiment, the gamma curve correction method is applied to a display apparatus, but not limited to this.

Please refer to FIG. 5. FIG. 5 illustrates a functional block diagram of the gamma curve correction circuit in a preferred embodiment of the invention. As shown in FIG. 5, the gamma curve correction circuit 5 includes a mapping module 50, a correction module 52, a register 54 and an output module 56. Wherein, the correction module 52 is coupled to the mapping module 50; the output module 56 is coupled to the register 54.

In this embodiment, the mapping module 50 maps a data to be outputted DOUT into an original mapped data DMAP1 via a plurality of original bonding points on a gamma curve. The plurality of original bonding points at least includes a first original bonding point, a second original bonding point and a third original bonding point. The second original bonding point is located between the first original bonding point and the third original bonding point. A first line between the first original bonding point and the second original bonding point has a first slope; a second line between the second original bonding point and third original bonding point has a second slope. The correction module 52 obtains a third line according to a first interpolating point on the first line and a second interpolating point on the second line. The third line has a third slope between the first slope and the second slope.

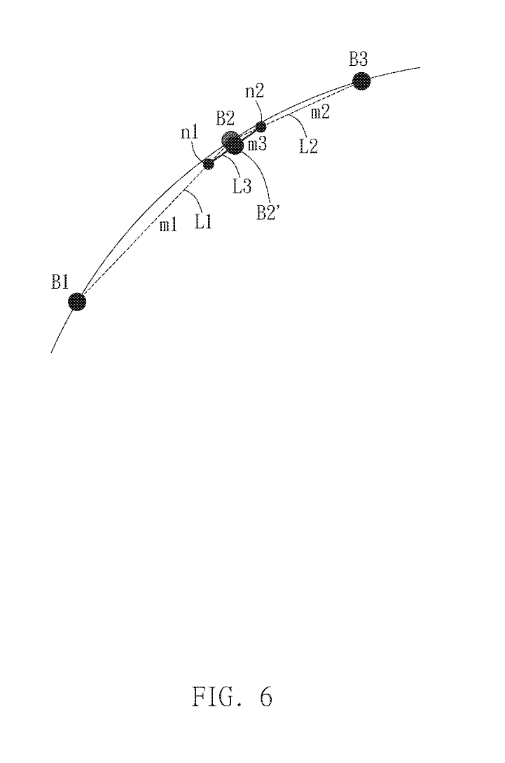

For example, as shown in FIG. 6, it is assumed that there are a first original bonding point B1, a second original bonding point B2 and a third original bonding point B3 on the gamma curve. The second original bonding point B2 is located between the first original bonding point B1 and the third original bonding point B3. A first line L1 between the first original bonding point B1 and the second original bonding point B2 has a first slope m1; a second line L2 between the second original bonding point B2 and third original bonding point B3 has a second slope m2. The correction module 52 obtains a third line L3 according to a first interpolating point n1 on the first line L1 and a second interpolating point n2 on the second line L2. The third line L3 has a third slope m3 and the third slope m3 is between the first slope m1 and the second slope m2.

Then, the correction module 52 can obtain a new bonding point B2′ according to an average of the first interpolating point n1 and the second interpolating point n2 and use the new bonding point B2′ to replace the second original bonding point B2. Afterwards, the registers 54 corresponding to the first original bonding point B1, the third original bonding point B3 and the new bonding point B2′ respectively will receive and store mapped codes of the first original bonding point B1, the third original bonding point B3 and the new bonding point B2′ respectively to obtain a corrected mapped code DMAP2. At last, the output module 56 will perform output a corresponding output voltage VOUT according to the corrected mapped code DMAP2.

In another embodiment, the correction module 52 can directly use the first interpolating point n1 and the second interpolating point n2 to replace the second original bonding point B2. Then, the registers 54 corresponding to the first original bonding point B1, the third original bonding point B3, the first interpolating point n1 and the second interpolating point n2 respectively will receive and store mapped codes of the first original bonding point B1, the third original bonding point B3, the first interpolating point n1 and the second interpolating point n2 respectively to obtain a corrected mapped code DMAP2. At last, the output module 56 will perform output a corresponding output voltage VOUT according to the corrected mapped code DMAP2.

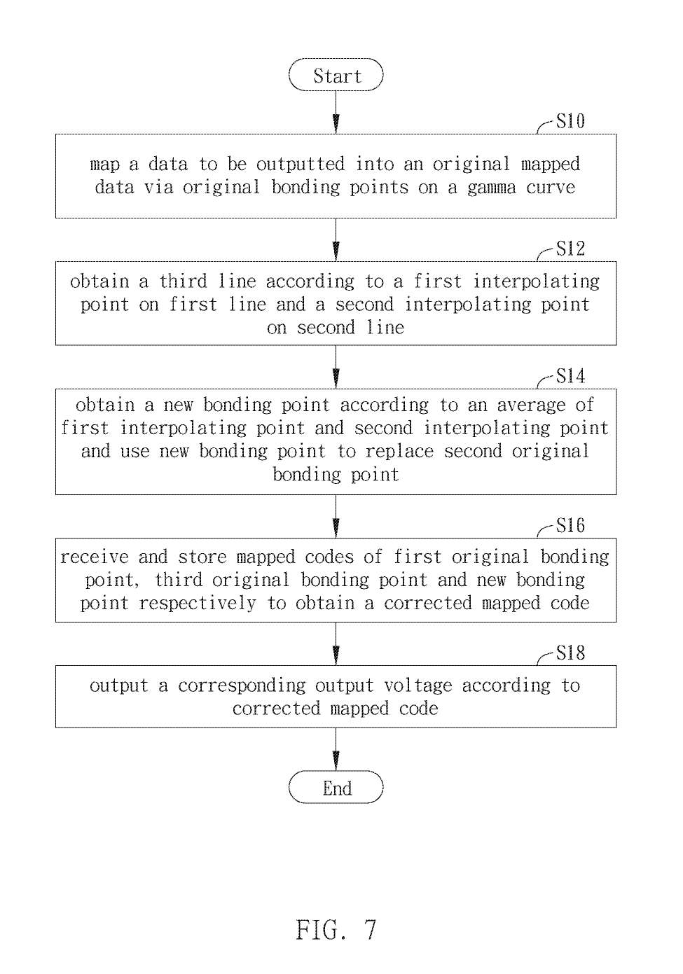

Another embodiment of the invention is a gamma curve correction method. In this embodiment, the gamma curve correction method is applied to a display apparatus, but not limited to this. Please refer to FIG. 7. FIG. 7 illustrates a flowchart of the gamma curve correction method in another preferred embodiment of the invention.

As shown in FIG. 7, at first, the gamma curve correction method performs the step S10 to map a data to be outputted into an original mapped data via a plurality of original bonding points on a gamma curve. Wherein, the plurality of original bonding points at least includes a first original bonding point, a second original bonding point and a third original bonding point; the second original bonding point is located between the first original bonding point and the third original bonding point; a first line between the first original bonding point and the second original bonding point has a first slope; a second line between the second original bonding point and third original bonding point has a second slope.

Then, the gamma curve correction method performs the step S12 to obtain a third line according to a first interpolating point on the first line and a second interpolating point on the second line, wherein the third line has a third slope and the third slope is between the first slope and the second slope.

Afterwards, the gamma curve correction method performs the step S14 to obtain a new bonding point according to an average of the first interpolating point and the second interpolating point and use the new bonding point to replace the second original bonding point. Then, the gamma curve correction method performs the step S16 to receive and store mapped codes of the first original bonding point, the third original bonding point and the new bonding point respectively to obtain a corrected mapped code. At last, the gamma curve correction method performs the step S18 to output a corresponding output voltage according to the corrected mapped code.

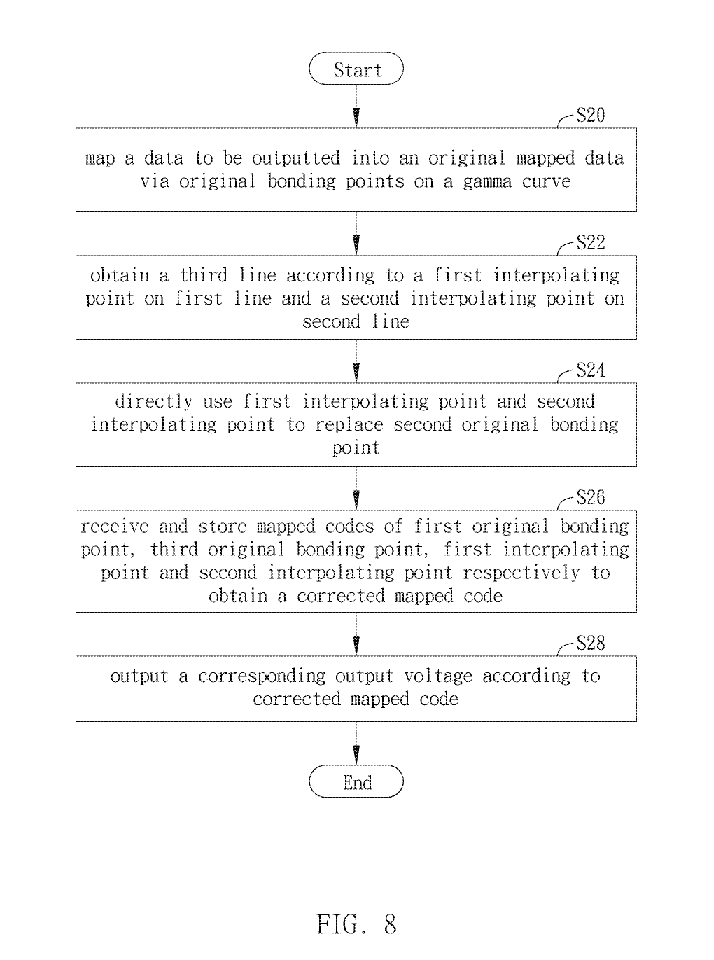

In another embodiment of the invention, as shown in FIG. 8, at first, the gamma curve correction method performs the step S20 to map a data to be outputted into an original mapped data via a plurality of original bonding points on a gamma curve. Wherein, the plurality of original bonding points at least includes a first original bonding point, a second original bonding point and a third original bonding point; the second original bonding point is located between the first original bonding point and the third original bonding point; a first line between the first original bonding point and the second original bonding point has a first slope; a second line between the second original bonding point and third original bonding point has a second slope.

Then, the gamma curve correction method performs the step S22 to obtain a third line according to a first interpolating point on the first line and a second interpolating point on the second line, wherein the third line has a third slope and the third slope is between the first slope and the second slope.

Afterwards, the gamma curve correction method performs the step S24 to directly use the first interpolating point and the second interpolating point to replace the second original bonding point. Then, the gamma curve correction method performs the step S26 to receive and store mapped codes of the first original bonding point, the third original bonding point, the first interpolating point and the second interpolating point respectively to obtain a corrected mapped code. At last, the gamma curve correction method performs the step S28 to output a corresponding output voltage according to the corrected mapped code.

Compared to the prior art, the gamma curve correction circuit and the gamma curve correction method of the invention can effectively improve the poor grey-level continuity of the gradient picture by correcting the bonding points where the slope is changed, so that the user can have a smooth visual experience about the brightness of the LCD panel.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

1. A gamma curve correction circuit disposed in a display apparatus, the gamma curve correction circuit comprising:
a mapping module configured to map a data to be outputted into an original mapped data via a plurality of original bonding points on a gamma curve, wherein the plurality of original bonding points at least comprises a first original bonding point, a second original bonding point and a third original bonding point; the second original bonding point is located between the first original bonding point and the third original bonding point; a first line between the first original bonding point and the second original bonding point has a first slope; a second line between the second original bonding point and third original bonding point has a second slope; and
a correction module coupled to the mapping module and configured to obtain a third line according to a first interpolating point on the first line and a second interpolating point on the second line, wherein the third line has a third slope and the third slope is between the first slope and the second slope.

2. The gamma curve correction circuit of claim 1, wherein the correction module obtains a new bonding point according to an average of the first interpolating point and the second interpolating point and uses the new bonding point to replace the second original bonding point.

3. The gamma curve correction circuit of claim 2, further comprising:
a register corresponding to the first original bonding point, the third original bonding point and the new bonding point respectively and configured to receive and store mapped codes of the first original bonding point, the third original bonding point and the new bonding point respectively to obtain a corrected mapped code; and
an output module coupled to the register and configured to output a corresponding output voltage according to the corrected mapped code.

4. The gamma curve correction circuit of claim 1, wherein the correction module uses the first interpolating point and the second interpolating point to replace the second original bonding point.

5. The gamma curve correction circuit of claim 4, further comprising:
a register corresponding to the first original bonding point, the third original bonding point, the first interpolating point and the second interpolating point respectively and configured to receive and store mapped codes of the first original bonding point, the third original bonding point and the first interpolating point and the second interpolating point respectively to obtain a corrected mapped code, wherein the first interpolating point and the second interpolating point output their mapped codes alternately in time or space; and
an output module coupled to the register and configured to output a corresponding output voltage according to the corrected mapped code.

6. A gamma curve correction method applied to a display apparatus, the gamma curve correction method comprising the steps of:
mapping a data to be outputted into an original mapped data via a plurality of original bonding points on a gamma curve, wherein the plurality of original bonding points at least comprises a first original bonding point, a second original bonding point and a third original bonding point; the second original bonding point is located between the first original bonding point and the third original bonding point; a first line between the first original bonding point and the second original bonding point has a first slope; a second line between the second original bonding point and third original bonding point has a second slope; and
obtaining a third line according to a first interpolating point on the first line and a second interpolating point on the second line, wherein the third line has a third slope and the third slope is between the first slope and the second slope.

7. The gamma curve correction method of claim 6, further comprising the step of:
obtaining a new bonding point according to an average of the first interpolating point and the second interpolating point and using the new bonding point to replace the second original bonding point.

8. The gamma curve correction method of claim 7, further comprising the steps of:
receiving and storing mapped codes of the first original bonding point, the third original bonding point and the new bonding point respectively to obtain a corrected mapped code; and
outputting a corresponding output voltage according to the corrected mapped code.

9. The gamma curve correction method of claim 6, further comprising the step of:
using the first interpolating point and the second interpolating point to replace the second original bonding point.

10. The gamma curve correction method of claim 9, further comprising the steps of:
receiving and storing mapped codes of the first original bonding point, the third original bonding point and the first interpolating point and the second interpolating point respectively to obtain a corrected mapped code, wherein the first interpolating point and the second interpolating point output their mapped codes alternately in time or space; and
outputting a corresponding output voltage according to the corrected mapped code.
